(19) United States
(12) Patent Application Publication
(10) Pub. No.: US 2024/0213497 A1
(43) Pub. Date: Jun. 27, 2024

(54) Battery Cell and Method for Producing a Battery Cell

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Frederik MORGENSTERN, San Francisco, CA (US); Seokyoon YOO, Muenchen (DE)

(21) Appl. No.: 18/569,444

(22) PCT Filed: May 19, 2022
(86) PCT No.: PCT/EP2022/063565

§ 371 Date: Dec. 12, 2023

(30) Foreign Application Priority Data
Jun. 18, 2021 (DE) 10 2021 115 798.6

(51) Int. Cl. H01M 4/75; H01M 10/04; H01M 50/107; H01M 50/148; H01M 50/152; H01M 50/531

(52) U.S. Cl. CPC H01M 4/75; H01M 10/0422; H01M 10/0431; H01M 50/107; H01M 50/152; H01M 50/154; H01M 50/531

(57) ABSTRACT

A battery cell includes: (i) a cylindrical cell housing having a hollow cylinder; (ii) an electrically conductive closure plate closing the hollow cylinder at an end face and having an opening; (iii) an electrode of a first electrical polarity and an electrode of a second electrical polarity opposite to the first polarity, the electrodes being separated by a separator; (iv) an electrically conductive rod, which extends along a longitudinal axis of the hollow cylinder as far as the opening, so that, at a first end of the rod, the rod is electrically contactable through the opening. The electrode of the first polarity is electrically connected to the closure plate. The electrode of the second polarity is electrically connected to the electrically conductive rod at a second end of the rod different from the first end, the electrically conductive rod being electrically isolated from the electrically conductive closure plate.

### BACKGROUND AND SUMMARY

The present invention relates to a battery cell and to a method for producing a battery cell.

In the field of battery cells, in particular lithium-ion battery cells, cylindrical, prismatic and pouch-shaped cells are predominantly known.

In the case of cylindrical battery cells, wound electrodes in particular can be installed in a cylindrical housing. The electrode ends can be connected to electrically conductive tabs, which are frequently referred to as “current collectors”, by means of which an electrical connection to the exterior of the cell can be formed, such that the voltage of the battery cell can be tapped off from the exterior. The respective tab thus forms an electrical connection of electrodes of the same polarity, such that the respective polarity can be tapped off from the exterior of the battery cell, at the tab. In particular, it is known that a current collector, which is electrically connected to the electrodes of a first polarity, can be electrically connected to the housing cover. Another current collector, which is connected to the electrodes of a second polarity, which is opposite to the first polarity, can be electrically connected to the housing, wherein the housing cover and the housing are electrically insulated from one another. As a result, a current path runs via the housing, for example via the cylindrical housing wall thereof.

The present invention is based on the object of providing a cylindrical battery cell, wherein the routing of current via the housing is avoided.

This object is achieved according to the teaching of the independent claims. Various embodiments and further developments of the invention are the subject matter of the dependent claims.

A first aspect of the invention relates to a battery cell, having: (i) a cylindrical cell housing comprising a hollow cylinder; (ii) an electrically conductive closure plate, which closes the hollow cylinder at one of the end faces thereof, and comprises a first opening; (iii) at least one electrode of a first electrical polarity and at least one electrode of a second electrical polarity, which is opposite to the first polarity, wherein the electrodes of different polarities are separated from one another by at least one separator; (iv) an electrically conductive rod, which extends along a longitudinal axis of the hollow cylinder, between the end faces of the hollow cylinder, as far as the first opening such that, at a first end of the rod, the rod is electrically contactable from the exterior of the cell housing, through the first opening. In this case, the at least one electrode of the first polarity is electrically connected to the closure plate. The at least one electrode of the second polarity is electrically connected to the electrically conductive rod, at a second end of the rod which differs from the first end, wherein the electrically conductive rod is electrically insulated from the electrically conductive closure plate.

By means of this arrangement, it is possible for the current paths between the electrodes of the first polarity or the second polarity and the two battery cell poles, which are able to be tapped off from the exterior, to respectively be able to run within the cell housing, without running via the cell housing itself, as a result of which the risk of any establishment of a voltage by the current path of the cell housing with another electrically polarized component that enters into contact with the cell housing can be reduced. Moreover, in the configuration of the cell housing, it is not necessary to consider that the cell housing can function as a current path. By way of example, a material can be selected for the cell housing, independently of any stipulated electrical conductivity.

The terms “comprises”, “contains”, “includes”, “has”, “having” or any other variant thereof as may be used herein are intended to cover non-exclusive inclusion. By way of example, a method or a device that comprises or has a list of elements is therefore not necessarily limited to those elements, but may include other elements that are not expressly listed or that are inherent in such a method or such a device.

Furthermore, unless expressly stated otherwise, “or” refers to an inclusive “or” and not to an exclusive “or”. For example, a condition A or B is satisfied by one of the following conditions: A is true (or present) and B is false (or absent), A is false (or absent) and B is true (or present), and both A and B are true (or present).

The terms “a” or “an” as used here are defined in the sense of “one or more”. The terms “another” and “a further” and any other variant thereof should be understood in the sense of “at least one other”.

“Electrical conductivity” or “electrically conductive” (and modifications thereof) is to be understood in the meaning of the invention in particular as a physical variable that indicates how strong the capability of a material is to conduct the electric current. “Electrically conductive” in the meaning of the invention is accordingly in particular to be understood as an electrical conductivity that (at 25° C.) is at least 106 S/m, thus at least corresponds to the conductivity of metals.

“Electrical insulation”, “electrically insulated” (and modifications thereof) is to be understood in the meaning of the invention in particular as a physical variable that indicates how a specific body used as an insulator at least substantially prevents a current flow upon application of a voltage. In particular, materials or bodies, the electrical conductivity of which is less than 10⁻⁸ S/cm or which have a specific resistance of greater than 108 Ω·cm, are designated as (electrical) insulators or (electrically) insulating.

Preferred embodiments of the battery cell will now be described below, each of which, unless expressly excluded or technically impossible, may be combined as desired with one another and with the further described other aspects of the invention.

According to some embodiments, the battery cell has an electrically conductive connector element, which is arranged in the first opening and is electrically connected to the first end of the rod, wherein the electrically conductive connector element is electrically insulated from the closure plate. Accordingly, during the production of the battery cell, the connector element can firstly be fitted to the closure plate, and the electrical connection between the connector element and the rod can be formed following the fitting of the closure plate to the cell housing.

According to some embodiments, the battery cell has a first electrically conductive intermediate plate comprising a second opening, through which the rod extends, wherein the first intermediate plate is arranged between the electrodes and the closure plate, and wherein the first intermediate plate is electrically connected to the at least one electrode of the first polarity and the closure plate. As a result, electrical contact-connection of the electrode of the first polarity can be executed by means of the first intermediate plate, and it is not necessary for the electrode to be directly connected to the closure plate. Accordingly, during the production of the battery cell, the electrode of the first polarity can be electrically connected to the first intermediate plate externally to the cell housing, and the electrode, with the first intermediate plate connected thereto, can be arranged in the cell housing thereafter. The electrical connection between the first intermediate plate and the closure plate can be executed following the fitting of the closure plate.

According to some embodiments, the battery cell has a second electrically conductive intermediate plate, which is electrically connected to the second end of the rod and to the at least one electrode of the second polarity, wherein the electrodes are arranged between the first and second intermediate plates. As a result, electrical contact-connection of the electrodes of the second polarity can be executed by means of the rod, via the second intermediate plate, and it is not necessary for the electrode to be directly connected to the rod. Furthermore, during the production of the battery cell, the electrode of the second polarity can be electrically connected to the second intermediate plate externally to the cell housing, and the electrode, with the second intermediate plate connected thereto, and with the rod connected thereto, can be arranged in the cell housing thereafter. The electrical connection between the rod and the connector element can be executed following the fitting of the closure plate.

According to some embodiments, the battery cell has an electrically conductive connecting element, which is respectively electrically and mechanically connected to the first intermediate plate and to the closure plate. This has the advantage that the spacing between the first intermediate plate and the closure plate can be variable, as this spacing can be bridged by the electrically conductive connecting element.

The electrically conductive connecting element can preferably be configured integrally with the first intermediate plate as a mechanical unit. An integral design can have improved stability, and fewer manufacturing steps may be necessary in the manufacturing process. It is also conceivable for the electrically conductive connecting element and the first intermediate plate to be produced separately, and to be mechanically connected at a later time. This can allow greater flexibility in the configuration of the individual parts.

According to some embodiments, the battery cell has a fastening element, which is arranged at one end face of the hollow cylinder, wherein the electrically conductive connecting element and the closure plate are fastened to the fastening element, and are electrically insulated from the fastening element. The fastening element therefore makes it possible to fasten both the closure plate, and the electrically conductive connecting element, to the fastening element. At the same time, the electrically conductive connecting element and the closure plate are electrically insulated from the fastening element. The configuration of the cell housing as a current path can therefore be avoided. In particular, the fastening element can be configured integrally with the housing of the battery cell, in particular with the hollow cylinder.

According to some embodiments, the fastening element has a ring with a slot, and the electrically conductive connecting element and the closure plate each project at least partially into the slot, thus forming a positive connection with the slot and the electrical insulation. The closure plate can therefore be fastened over its full periphery, as a result of which a high degree of stability is achieved.

According to some embodiments, the rod and the second intermediate plate form a mechanical unit, which is configured integrally. An integral design can have improved stability, and fewer manufacturing steps may be necessary in the manufacturing process. It is also conceivable for the rod and the second intermediate plate to be produced separately, and to be mechanically connected at a later time. This can allow greater flexibility in the configuration of the individual parts.

According to some embodiments, the battery cell has a base plate, which closes the hollow cylinder at its other end face, with a slot, in particular an arc-shaped slot, which defines a surface region of the base plate such that, in response to the effect of force, the defined region can be broken out from the base plate. It can thus be achieved that, in response to a gas overpressure generated in the cell housing, the defined region is broken out from the base plate in response to the gas pressure, and the gas can escape from the cell housing.

According to some embodiments, the cylindrical cell housing comprises an electrically conductive material. This can be advantageous in order to be able to determine or measure the voltage that is present at the cell housing. Structures of a battery cell involving the employment of the present invention are also conceivable, which can be implemented in a technically simpler manner, if the cell housing is electrically conductive. It is conceivable for electrical insulation between the cell housing and a negative electrode to be omitted. In particular, in the case of a cell housing formed of steel, particularly of nickel, or nickel-coated steel or high-grade steel, it is possible for electrical insulation between a negative electrode that can contain copper, or between an intermediate plate that is electrically connected to this electrode, and the cell housing formed of steel, to be omitted. It is also conceivable for electrical insulation between the second intermediate plate and the cell housing to be omitted. In particular if the rod comprises copper, electrical insulation between the second intermediate plate and the base plate could be omitted. If the cell housing comprises steel and the rod comprises aluminum, electrical insulation between the first intermediate plate, which can comprise copper, and the closure plate could be omitted. This is due to the electrochemical stability of metals. In particular copper, nickel-coated steel, or nickel, or high-grade steel can have an electrochemical stability that is sufficient during operation when a negative potential is applied. When there is a positive potential at an electrode that comprises aluminum, a passivating layer can arise in combination with salts of an electrolyte. It is also conceivable for electrical insulation between the base plate and the second intermediate plate, which can have a positive electrode, to be omitted, in particular if the base plate and the second intermediate plate comprise aluminum.

A second aspect of the invention relates to a method for producing a battery cell, comprising the steps of: (i) arranging at least one electrode of a first electrical polarity and at least one electrode of a second electrical polarity, which is opposite to the first polarity, in a cylindrical cell housing comprising a hollow cylinder, wherein the hollow cylinder has a closing electrically conductive closure plate at one of the end faces thereof, which closure plate comprises a first opening, wherein the electrodes of different polarities are separated from one another by at least one separator; and wherein the electrodes and the separator have been wound around an electrically conductive rod, wherein the rod extends along a longitudinal axis of the hollow cylinder, between the end faces of the hollow cylinder, as far as the first opening such that, via a first end of the rod, the rod is electrically contactable from the exterior of the cell housing, through the first opening; (ii) producing an electrical connection between the at least one electrode of the first electrical polarity and the closure plate; (iii) producing an electrical connection between the at least one electrode of the second electrical polarity and the electrically conductive rod, at a second end of the rod, wherein the electrically conductive rod is electrically insulated from the electrically conductive closure plate.

The features and advantages explained in relation to the first aspect of the invention also apply correspondingly to the further aspects of the invention.

Further advantages, features and application possibilities of the present invention emerge from the following detailed description in conjunction with the figures, in which

### BRIEF DESCRIPTION OF THE DRAWINGS

FIG. 1 schematically shows a battery cell according to a first exemplary embodiment of the invention.

FIG. 2 schematically shows a battery cell according to a second exemplary embodiment of the invention.

FIG. 3A schematically shows a side view of a second intermediate plate with a mandrel.

FIG. 3B schematically shows a plan view of the second intermediate plate with the mandrel.

FIG. 4 schematically shows a plan view of a base plate with a slot.

FIGS. 5A-5F schematically show some production steps for producing the battery cell.

FIG. 6 schematically shows an illustrated flow diagram for illustrating a preferred embodiment of the method according to the invention.

### DETAILED DESCRIPTION OF THE DRAWINGS

Throughout the figures, the same reference signs are used for the same or mutually corresponding elements of the invention.

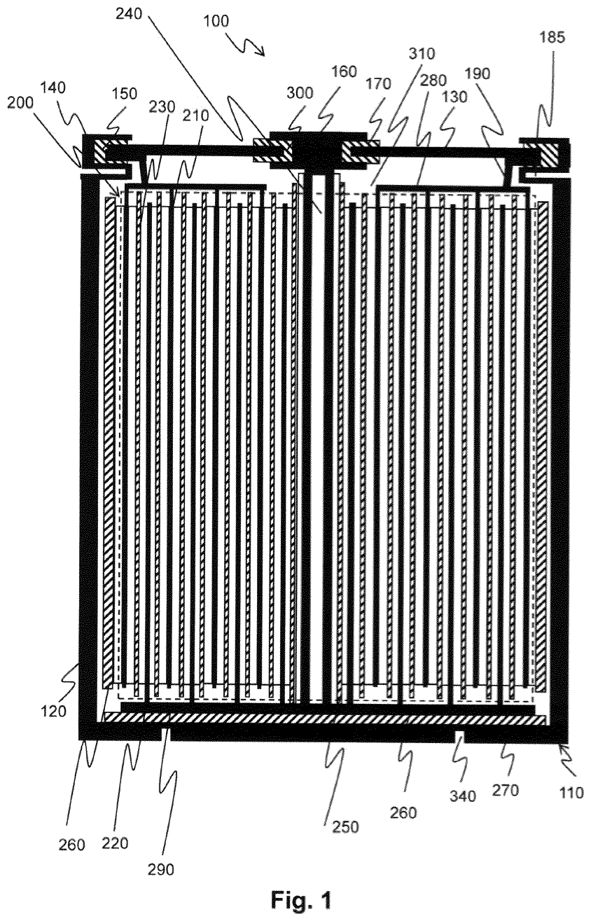

FIG. 1 schematically shows a battery cell 100 according to a first exemplary embodiment of the invention. The battery cell 100 has a cell housing 110 comprising a hollow cylinder 120 and an electrically conductive closure plate 130 comprising a first opening 300.

An electrode winding 200 is arranged within the hollow cylinder 120. The electrode winding 200 has first electrodes 210 with a first polarity, and second electrodes 220 with a second polarity, which is opposite to the first polarity. The electrode winding 200 is arranged in the cell housing 110 such that electrodes of the first polarity 210 and electrodes of the second polarity 220 are arranged alternately in the radial direction. A respective separator 230 is arranged between the electrodes of first polarity 210 and the electrodes of second polarity 220 such that the electrodes of different polarities are electrically insulated from one another, wherein the separator 230 comprises an electrically insulating material. The electrodes of first polarity 210 are surrounded by a first active material, and the electrodes of second polarity 220 are surrounded by a second active material. In the case of lithium-ion battery cells, the anode can comprise graphite and has a negative polarity. The cathode, which has a positive polarity, can comprise mixed metal oxide comprising lithium. During operation of the battery cell, the lithium ions can be moved from the negative anode to the positive cathode by the separator, which can comprise a polymer.

The electrodes 210, 220, with the surrounding active materials and the separator 130, are wound around an electrically conductive mandrel 240. The mandrel 240 extends along the longitudinal axis of the hollow cylinder 240. A third electrically insulating element 250 is arranged between the mandrel 240 and the electrode winding 200, as a result of which the electrode winding 200 is electrically insulated from the mandrel 240. A respective fourth electrically insulating element is arranged between the side walls of the hollow cylinder 120 and the electrode winding 200, and a base plate 270 of the cell housing 110 and the electrode winding 200, as a result of which the electrode winding 200 is electrically insulated from the side walls of the hollow cylinder 120 and from the base plate 270, respectively.

A first electrically conductive intermediate plate 280 is arranged between the closure plate 130 and the electrode winding 200. Some electrodes of the first or second polarity 210, 220 are electrically connected to the first intermediate plate 280. The first intermediate plate 280 is electrically connected to the closure plate 130, which is designed so as to be radially symmetrical with respect to the longitudinal axis of the hollow cylinder, via an electrically conductive connecting element 190. The first electrically conductive intermediate plate 280 has a circular surface and a second opening 310 in the central region of the circular surface thereof, through which the mandrel 240 extends.

A fastening ring with a slot 140 is arranged on one of the end faces of the hollow cylinder 120. The slot of the fastening ring 140 runs on the inner side of the ring. The fastening ring with the slot 140 is spaced apart from the hollow cylinder 120 by a circular slot 185 adjoining in a radial direction. The circular slot 185 is designed so as to be radially symmetrical with respect to the longitudinal axis of the hollow cylinder 120, wherein an opening of the circular slot 185 faces away from the hollow cylinder 120 in the radial direction. The hollow cylinder 120, the circular slot 185 and the fastening ring with a slot 140 can be configured integrally or in multipart form. A peripheral region of the closure plate 130 and a peripheral region of the connecting element are fastened within the slot of the fastening ring 140. A first electrically insulating element 150 is arranged in the slot, with the result that the closure plate 130 and the connecting element 190 are electrically insulated from the fastening ring with the slot 140. The closure plate 130 has a circular surface, wherein the first opening 300 is arranged in the center of the surface. A rivet 160, in particular a solid rivet, is arranged in the first opening 300. A second electrically insulating element 170, for example an electrically insulating layer made of plastic, is arranged between the rivet 160 and the closure plate 130.

A second electrically conductive intermediate plate 290 is arranged between the base plate 270 and the electrode winding 200, wherein the fourth electrically insulating element 260 is arranged between the second electrically conductive intermediate plate 290 and the base plate 270, with the result that the second electrically conductive intermediate plate 290 is arranged so as to be electrically insulated from the base plate 270. The other electrodes of the first or second polarity 210, 220 are electrically connected to the second intermediate plate 290. The second intermediate plate 290 has a circular surface. The second intermediate plate 290 is electrically and mechanically connected to the mandrel 240 in the center of the surface. The mandrel 240 and the second intermediate plate 290 can be configured integrally or in two-part form. A sleeve or a hollow cylinder can also be used instead of a mandrel. The mandrel 240 extends from the second intermediate plate 290, through the second opening 310 of the first intermediate plate 280, up to the rivet 160, to which the mandrel 240 is electrically and mechanically connected.

An arc-shaped slot 340 is also provided in the base plate 270 and encloses a region of the base plate 270. If the gas pressure increases within the battery cell 100 due to a malfunction, beyond a certain gas pressure, the part enclosed by the slot breaks out from the base plate 270, with the result that the gas can escape from the battery cell. Given that the slot does not describe a complete circle, the broken-out part remains connected to the base plate 270 and does not fall into the cell housing 110.

In a first variant of the first exemplary embodiment, the polarities of the electrodes 210, 220 are arranged such that an electrical negative pole is present at the closure plate 130, and this is simultaneously an anode. In this case, the closure plate can comprise a nickel-coated steel, high-grade steel or copper. The first intermediate plate that is electrically connected to the closure plate 130 comprises copper. An electrical positive pole is present at the connector element 280, and this is simultaneously a cathode. The connector element 280 comprises aluminum. The mandrel 240 and the second intermediate plate 290 both comprise aluminum.

In a second variant of the first exemplary embodiment, the polarities of the electrodes 210, 220 are arranged such that an electrical positive pole is present at the closure plate 130, and this is simultaneously a cathode. In this case, the closure plate comprises aluminum. The first intermediate plate that is electrically connected to the closure plate 130 comprises aluminum. An electrical negative pole is present at the connector element 280, and this is simultaneously an anode. The connector element 280 comprises a nickel-coated steel or copper. The mandrel 240 and the second intermediate plate 290 both comprise copper. Copper can be advantageous as material for the mandrel 240 because the mandrel 240 can be manufactured to be thinner, or to have thinner walls, and therefore becomes smaller and lighter. In addition, copper has a lower electrical resistance compared to aluminum.

On account of this arrangement, both the negative pole and the positive pole can be tapped off at the same end face of the hollow cylinder 120 at the closure plate 130 and the rivet 160 that is arranged in the first opening 300 of the closure plate 130 so as to be electrically insulated from the closure plate 130. As a result, the current paths run within the cell housing 110, but not via the cell housing 110.

In this case, it is advantageous to use the first electrically insulating element 150, in particular if the cell housing comprises steel, and the potential of the cell housing 110 is intended to be neutral. It can also be advantageous to use the first electrically insulating element 150 if the first intermediate plate 280 comprises aluminum. Mechanical and electrical contact between the cell housing 110 and the first intermediate plate 280 can lead to an unstable potential if the cell housing 110 comprises steel, in particular nickel, nickel-coated steel or high-grade steel, and the first closure plate 280 comprises aluminum. It can be advantageous to use the fourth electrically insulating element 260, in particular if the cell housing 110 comprises steel and the second intermediate plate 290 comprises copper, but the potential of the cell housing 110 is intended to be neutral. It can also be advantageous to use the fourth electrically insulating element 260 if the second intermediate plate 290 comprises aluminum because mechanical and electrical contact between the cell housing 110 and the second intermediate plate 290 can lead to an unstable potential, in particular if the cell housing 110 comprises steel and the first closure plate 280 comprises aluminum.

It is also conceivable to omit the first electrically insulating element 150, in particular if the first electrode 210 has a negative polarity. In particular if the cell housing 110 comprises steel, in particular nickel or nickel-coated steel, the first electrically insulating element 150 that is arranged between the first intermediate plate 280, which is connected to the negative first electrode 210 that can comprise copper, and the cell housing 110 made of steel could be omitted. It is also conceivable to omit the fourth electrically insulating element 260 that is arranged between the second intermediate plate 290 and the base plate 270. In particular if the mandrel 240 comprises copper, the fourth electrically insulating element 260 that is arranged between the second intermediate plate 290 and the base plate 270 could be omitted. If the cell housing 110 comprises steel and the mandrel 240 comprises aluminum, the first electrically insulating element 150 could likewise be omitted. This is due to the electrochemical stability of metals. In particular copper, nickel-coated steel, or nickel, or else high-grade steel can have an electrochemical stability that is sufficient during operation when a negative potential is applied. When there is a positive potential at an electrode 210, 220 that comprises aluminum, a passivating layer can be formed in combination with salts of an electrolyte. It would also be conceivable for the cell housing 110 to comprise aluminum. In this case, the cell housing 110 could be electrically connected to the second intermediate plate 290 if the second intermediate plate 290 likewise comprises aluminum.

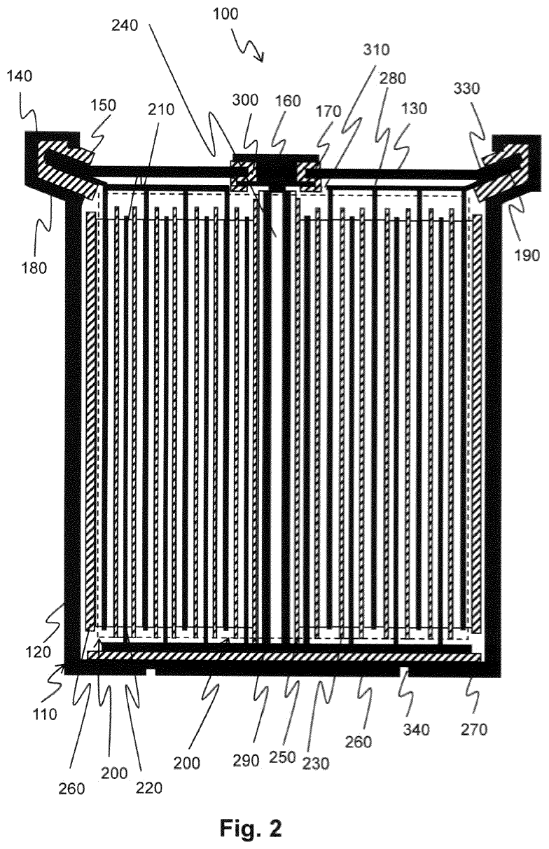

FIG. 2 schematically shows a battery cell 100 according to a second exemplary embodiment. In contrast to the first exemplary embodiment according to FIG. 1, in the present second exemplary embodiment, the closure plate 130 has a radially outwardly extending and circumferential oblique peripheral region. The first intermediate plate 280 also has an oblique peripheral region 190 that extends outwardly with respect to the circular surface. The obliquely extending peripheral region 190 of the first intermediate plate 280 is electrically and mechanically connected to the oblique peripheral region of the closure plate 330. The obliquely extending peripheral regions 330, 190 face away from the hollow cylinder 120 in respect of the longitudinal axis of the hollow cylinder 120. The peripheral regions 330, 190 of the closure plate 130 and the first intermediate plate 280 are fastened in the slot of the fastening ring 140. Instead of the circular slot 185 from FIG. 1, in this exemplary embodiment a beveled overhang 180 connects the hollow cylinder 120 to the fastening ring 140, wherein the beveled overhang 180 forms one of the delimiting side walls that define the slot of the fastening ring 140. The beveled overhang 180 extends radially outwards from an outer wall of the hollow cylinder 120 on the end face of the closure plate 130. The fastening ring 140 at least partially has a diameter that is greater than a diameter of the hollow cylinder 120 in a region within which the electrode winding 200 is arranged. Given that the peripheral regions 190, 330 of the first intermediate plate 280 and the closure plate 130 are arranged in the fastening ring 140 that is radially and axially offset in comparison to the first exemplary embodiment, the spacing in particular increases in the axial direction between the electrode winding 200 and the closure plate 130. As a result, the height of the battery cell 100 is increased, with the result that a taller and therefore larger electrode winding 200 with more capacitance can be arranged in the cell housing 110. Furthermore, due to the radial extent of the fastening ring 140 toward the outside, a spacing can be formed between battery cells arranged next to one another. This spacing can make it possible to arrange lateral cooling between the battery cells.

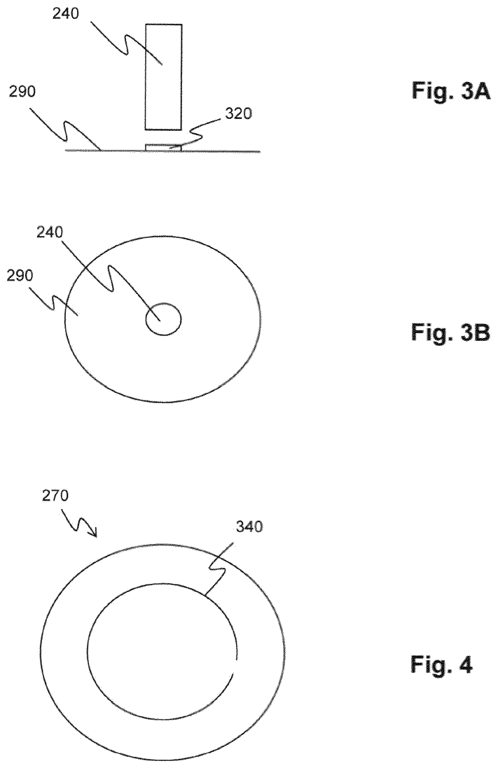

FIG. 3A schematically shows a side view of a second intermediate plate 290 with a mandrel 240. The second intermediate plate 290 has a circular surface. A projection 320 is arranged in the central region of the surface. The mandrel 240 is electrically and mechanically connected to the second intermediate plate 290 at this projection 320, for example using a welding method. A sleeve can also be used instead of a mandrel 240. The mandrel 240 and the second intermediate plate 290 can both be made of aluminum or both be made of copper, depending on the embodiment variants described in FIG. 1. The mandrel 240 and the second intermediate plate 290 with the projection 320 can also be configured integrally as a mechanical unit, for example by means of a deep-drawing method.

FIG. 3B schematically shows a plan view of the second intermediate plate 290 and the mandrel 240.

FIG. 4 schematically shows a plan view of a base plate 270 with a slot 340. The slot 340 is designed to be arc-shaped. If the gas pressure increases within the cell housing 110 of the battery cell 100 due to a malfunction, beyond a certain gas pressure, the part enclosed by the arc breaks out from the base plate 270, with the result that the gas can escape from the battery cell. Given that the slot describes an arc and not a complete circle, the broken-out part remains connected to the base plate 270 and does not fall into the cell housing 110.

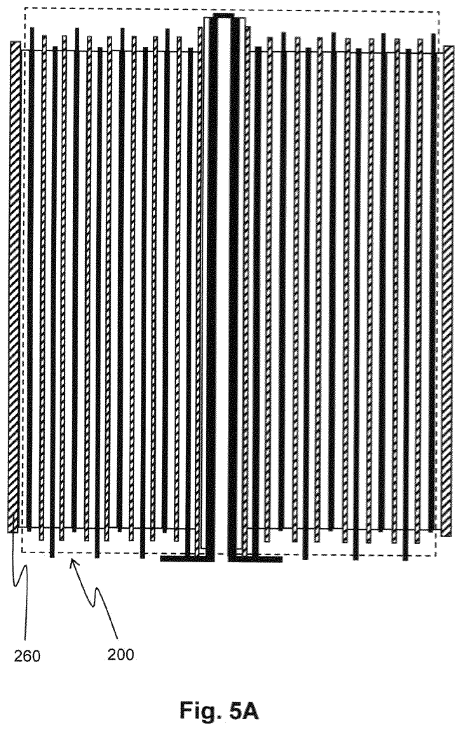

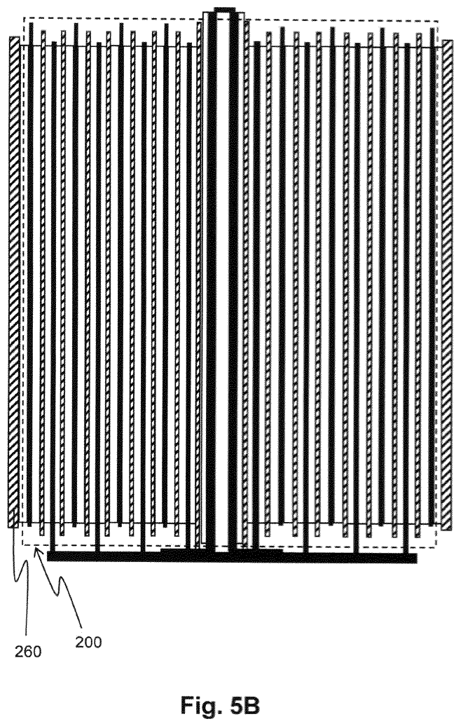

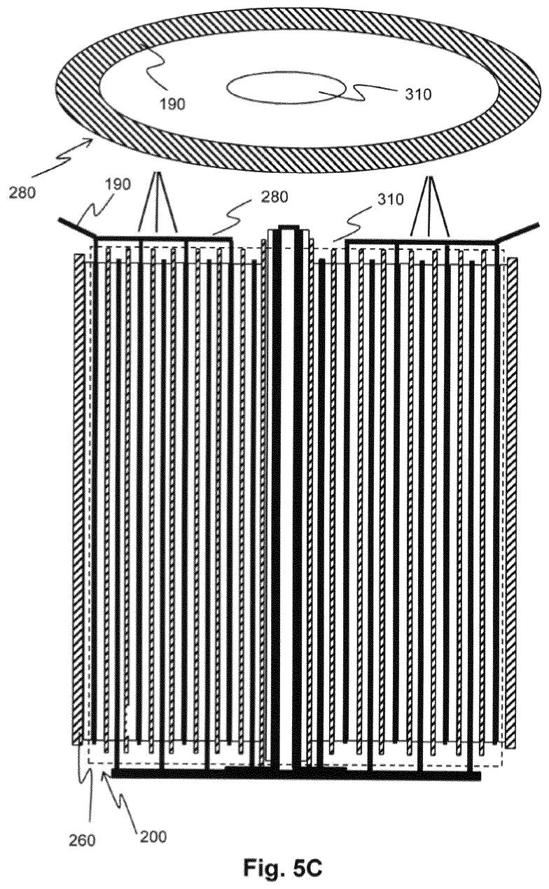

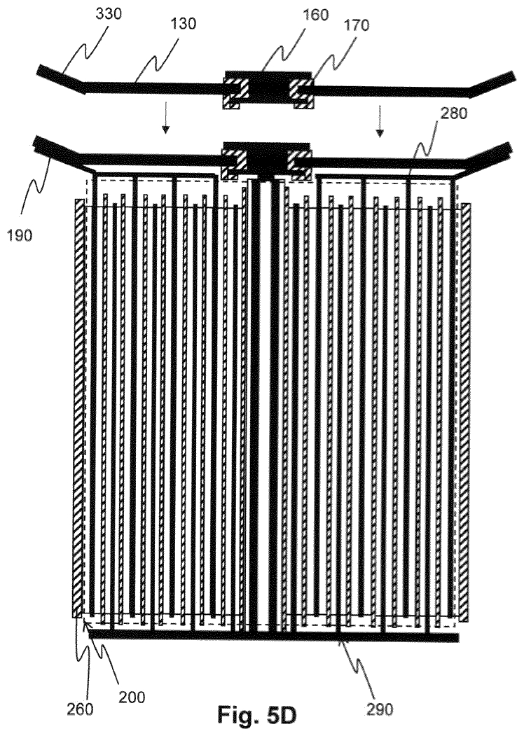

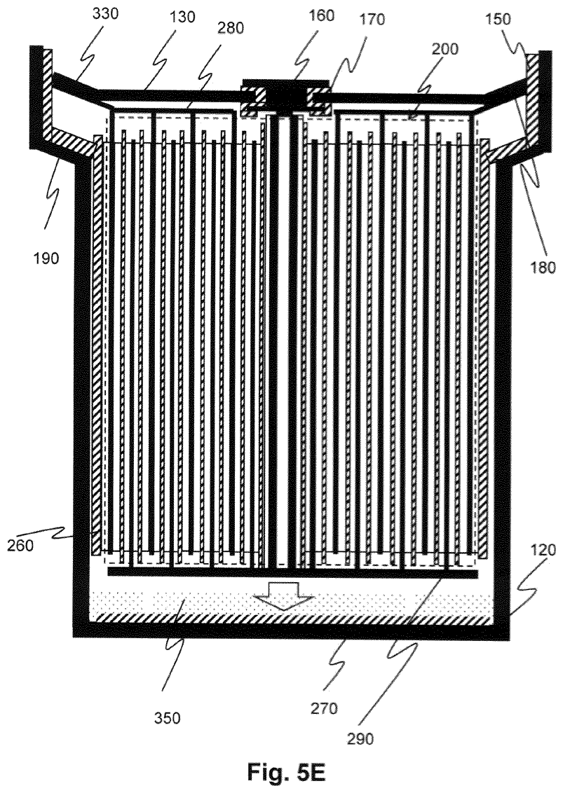

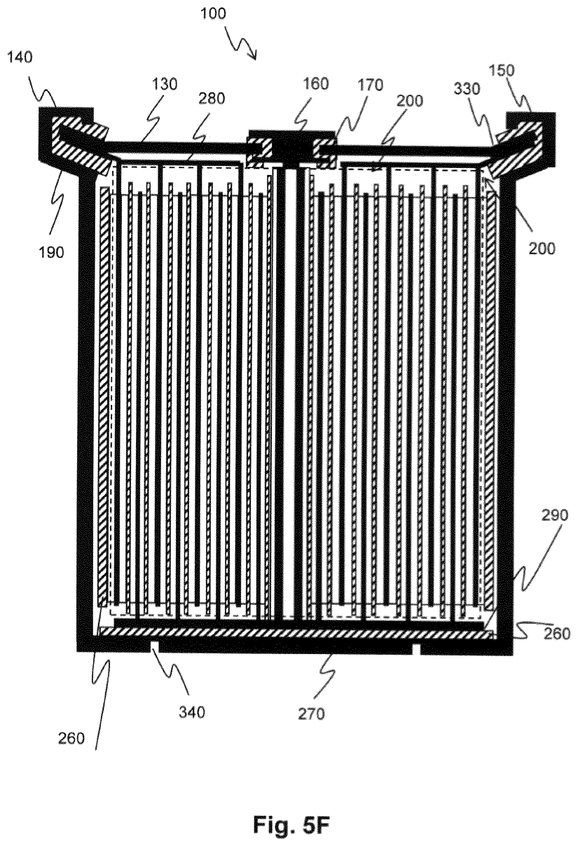

FIGS. 5A-5F schematically show some production steps for producing the battery cell according to FIG. 2.

FIG. 5A schematically shows an electrode winding 200, see the region that is framed with dashed lines. The electrode winding 200 is formed by winding a first electrode 210 with a first polarity and a second electrode 220 with a second polarity, which is opposite to the first polarity, around a mandrel 240, and by arranging a separator 230 between them. The electrodes 210, 220 are each surrounded by an active material, wherein one of the materials comprises lithium, with the result that lithium ions can move through the separator 230 from one electrode 210, 220 to the other electrode 210, 220 when the battery cell is being charged or discharged. A third electrically insulating element is arranged between the mandrel 240 and the electrode winding 200, as a result of which the electrode winding 200 is electrically insulated from the mandrel 240.

FIG. 5B schematically shows the attachment of the second intermediate plate 290, which is described in FIGS. 1 and 2, to some electrodes 220, and to the mandrel 240. This can be carried out by means of a welding process in each case, with the result that an electrical and materially bonded connection is formed. In this embodiment variant, the mandrel 240 and the second intermediate plate 290 comprise aluminum.

FIG. 5C schematically shows the attachment of the first intermediate plate 280, which is described in FIG. 2, to the other electrodes 210. The attachment can be carried out by means of a welding process, with the result that an electrical and materially bonded connection is formed. In this embodiment variant, the first intermediate plate 290 comprises copper. The first intermediate plate 280 has a peripheral region 190 that extends obliquely with respect to the circular surface and faces away from the electrode winding 200 in the mounted state.

FIG. 5D schematically shows the attachment of the closure plate 130. In this case, the peripheral region of the closure plate 330 is electrically and mechanically connected to the peripheral region 190 of the first intermediate plate 280, for example using a welding method. A rivet 160, in particular a solid rivet, made of an electrically conductive material is arranged in the first opening 300 of the closure plate 130. A first electrically insulating element 150 is arranged between the rivet 160 and the closure plate 130. The rivet 160 is electrically and mechanically connected to the mandrel 240, for example by means of a welding method, wherein the welding device is arranged outside of the cell housing.

FIG. 5E schematically shows the arrangement of the electrode winding 200 according to FIG. 5D in the cell housing 110. Electrolyte 350 is furthermore shown, which is filled into the cell housing 110 before the cell housing 110 is closed. After the filling of the electrolyte 350, the electrode winding 200 according to FIG. 5D moves in the direction of the base plate 270 in accordance with the direction of the arrow shown.

FIG. 5F schematically shows the final adjustment of the electrode winding 200. In this case, a positive connection is formed between the closure plate 130 and the fastening ring with a slot 140, wherein a first electrically insulating element 150 is arranged between the fastening ring with a slot 140 and the closure plate 130.

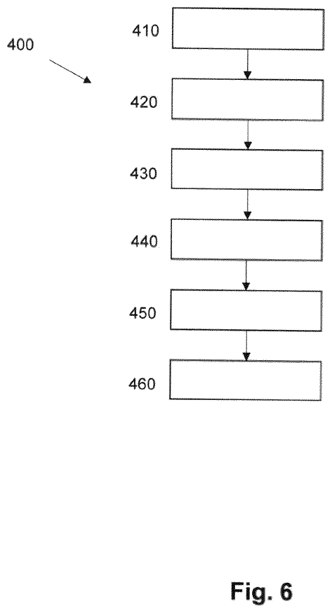

FIG. 6 schematically shows an illustrated flow diagram 400 for illustrating a preferred embodiment of the method according to the invention, comprising the steps of:

Producing 410 an electrode winding 200, according to FIG. 5A, by winding a first electrode 210 with a first polarity and a second electrode 220 with a second polarity, which is opposite to the first polarity, around a mandrel 240, wherein a separator 230 is arranged between the electrodes 210, 220 of different polarities. The electrodes 210, 220 are each surrounded by an active material, wherein one of the materials comprises lithium, with the result that lithium ions can move through the separator 230 from one electrode 210, 220 to the other electrode 210, 220 when the battery cell is being charged or discharged.

Producing 420 an electrical and mechanical connection between the second electrically conductive intermediate plate 290, which is described in FIGS. 1 and 2, and electrodes of the second polarity 220, and the electrically conductive mandrel 240, according to FIG. 5B.

Producing 430 an electrical and mechanical connection between the first electrically conductive intermediate plate 280, which is described in FIG. 1, and electrodes of the first polarity 210, according to FIG. 5C.

Producing 440 an electrical and mechanical connection between the electrically conductive closure plate 130, which is described in FIG. 2, and the first electrically conductive intermediate plate 280, according to FIG. 5D.

Arranging 450 the electrode winding 200 in a cell housing 110 filled with an electrolyte 350, according to FIG. 5E.

Fastening 460 the closure plate 130 to the cell housing 110, according to FIG. 5F.

The particular advantage of this method is that the required welding method according to method steps 420-440 and FIGS. 5B-5D can be carried out outside of the cell housing. This makes it possible avoid the situation in which particles arising during the welding process enter the cell housing.

While at least one exemplary embodiment has been described above, it should be noted that there are a large number of variations in this respect. It should also be noted here that the described exemplary embodiments constitute only non-limiting examples and they are not thereby intended to limit the scope, applicability or configuration of the devices and methods described here. Instead, the above description will provide a person skilled in the art with an indication for the implementation of at least one exemplary embodiment, wherein it is understood that various changes in the means of functioning and the arrangement of the elements described in an exemplary embodiment can be made without in the process departing from the subject matter respectively defined in the appended claims or its legal equivalents.

### LIST OF REFERENCE SIGNS

100 Battery cell
110 Cell housing
120 Hollow cylinder
130 Closure plate
140 Fastening ring with a slot
150 First electrically insulating element
160 Rivet
170 Second electrically insulating element
180 Beveled overhang
185 Circular slot
190 Connecting element
200 Electrode winding
210 Electrodes of the first polarity
220 Electrodes of the second polarity
230 Separator
240 Mandrel
250 Third electrically insulating element
260 Fourth electrically insulating element
270 Base plate
280 First intermediate plate
290 Second intermediate plate
300 First opening
310 Second opening
320 Projection
330 Peripheral region of the closure plate
340 Arc-shaped slot
350 Electrolyte
400 An illustrated flow diagram for illustrating a preferred embodiment of the method according to the invention for producing a battery cell
410-460 Method steps of the method according to the invention

1.-11. (canceled)

12. A battery cell comprising:
a cylindrical cell housing including a hollow cylinder;
an electrically conductive closure plate, which closes the hollow cylinder at a first end face of the hollow cylinder and includes a first opening;
at least one electrode of a first electrical polarity and at least one electrode of a second electrical polarity, which is opposite to the first polarity, wherein the electrodes of different polarities are separated from one another by at least one separator;
an electrically conductive rod, which extends along a longitudinal axis of the hollow cylinder, between the first end face and a second end face of the hollow cylinder, as far as the first opening such that, at a first end of the rod, the rod is electrically contactable from the exterior of the cell housing, through the first opening;
wherein:
the at least one electrode of the first polarity is electrically connected to the closure plate;
the at least one electrode of the second polarity is electrically connected to the electrically conductive rod, at a second end of the electrically conductive rod which differs from the first end; wherein the electrically conductive rod is electrically insulated from the electrically conductive closure plate.

13. The battery cell according to claim 1, further comprising an electrically conductive connector element, which is arranged in the first opening and is electrically connected to the first end of the electrically conductive rod, wherein the electrically conductive connector element is electrically insulated from the closure plate.

14. The battery cell according to claim 12, further comprising a first electrically conductive intermediate plate including a second opening, through which the electrically conductive rod extends, wherein the first intermediate plate is arranged between the electrodes and the closure plate, and wherein the first intermediate plate is electrically connected to the at least one electrode of the first polarity and the closure plate.

15. The battery cell according to claim 13, further comprising a first electrically conductive intermediate plate including a second opening, through which the electrically conductive rod extends, wherein the first intermediate plate is arranged between the electrodes and the closure plate, and wherein the first intermediate plate is electrically connected to the at least one electrode of the first polarity and the closure plate.

16. The battery cell according to claim 12, further comprising a second electrically conductive intermediate plate, which is electrically connected to the second end of the electrically conductive rod and to the at least one electrode of the second polarity, wherein the electrodes are arranged between the first intermediate plate and the second intermediate plate.

17. The battery cell according to claim 13, further comprising a second electrically conductive intermediate plate, which is electrically connected to the second end of the electrically conductive rod and to the at least one electrode of the second polarity, wherein the electrodes are arranged between the first intermediate plate and the second intermediate plate.

18. The battery cell according to claim 14, further comprising a second electrically conductive intermediate plate, which is electrically connected to the second end of the electrically conductive rod and to the at least one electrode of the second polarity, wherein the electrodes are arranged between the first intermediate plate and the second intermediate plate.

19. The battery cell according to claim 14, further comprising an electrically conductive connecting element, which is respectively electrically and mechanically connected to the first intermediate plate and to the closure plate.

20. The battery cell according to claim 16, further comprising an electrically conductive connecting element, which is respectively electrically and mechanically connected to the first intermediate plate and to the closure plate.

21. The battery cell according to claim 19, further comprising a fastening element, which is arranged at one end face of the hollow cylinder, wherein the electrically conductive connecting element and the closure plate are fastened to the fastening element, and are electrically insulated from the fastening element.

22. The battery cell according to claim 21, wherein the fastening element has a ring with a slot, and the electrically conductive connecting element and the closure plate both project at least partially into the slot, thus forming a positive connection with the slot and the electrical insulation.

23. The battery cell according to claim 12, wherein the electrically conductive rod and the second intermediate plate form a mechanical unit, which is configured integrally.

24. The battery cell according to claim 13, wherein the electrically conductive rod and the second intermediate plate form a mechanical unit, which is configured integrally.

25. The battery cell according to claim 14, wherein the electrically conductive rod and the second intermediate plate form a mechanical unit, which is configured integrally.

26. The battery cell according to claim 12, further comprising a base plate, which closes the hollow cylinder at its other end face, with a slot, which defines a surface region of the base plate such that, in response to the effect of force, the defined region can be broken out from the base plate.

27. The battery cell according to claim 12, wherein the cylindrical cell housing comprises an electrically conductive material.

28. The battery cell according to claim 13, wherein the cylindrical cell housing comprises an electrically conductive material.

29. The battery cell according to claim 14, wherein the cylindrical cell housing comprises an electrically conductive material.

30. A method for producing a battery cell, the method comprising:
arranging at least one electrode of a first electrical polarity and at least one electrode of a second electrical polarity, which is opposite to the first polarity, in a cylindrical cell housing including a hollow cylinder, wherein the hollow cylinder has an electrically conductive closure plate at a first end face of the hollow cylinder, the electrically conductive closure plate including a first opening, wherein the electrodes of different polarities are separated from one another by at least one separator; and
wherein the at least one electrode of the first electrical polarity, the at least one electrode of the second electrical polarity and the separator have been wound around an electrically conductive rod, wherein the electrically conductive rod extends along a longitudinal axis of the hollow cylinder, between the first end face and a second end face of the hollow cylinder, as far as the first opening such that, via a first end of the electrically conductive rod, the electrically conductive rod is electrically contactable from the exterior of the cell housing, through the first opening;
producing an electrical connection between the at least one electrode of the first electrical polarity and the closure plate; and
producing an electrical connection between the at least one electrode of the second electrical polarity and the electrically conductive rod, at a second end of the electrically conductive rod, wherein the electrically conductive rod is electrically insulated from the electrically conductive closure plate.
